(19) United States
(12) Patent Application Publication
(10) Pub. No.: US 2023/0335304 A1
(43) Pub. Date: Oct. 19, 2023

(54) METHOD FOR IMPROVING THE WITHSTANDING CAPABILITY OF THE CLADDING MATERIAL IN THE FAST NEUTRON IRRADIATION ENVIRONMENT

(71) Applicant: Xi' an Jiaotong University, Xi' an (CN)

(72) Inventors: Di Yun, Xi' an (CN); Zhaohao Wang, Xi' an (CN); Chunyang Wen, Xi' an (CN); Tiantian Shi, Xi' an (CN); Linna Feng, Xi' an (CN); Wenbo Liu, Xi' an (CN); Jianqiang Shan, Xi' an (CN)

(21) Appl. No.: 17/850,238

(22) Filed: Jun. 27, 2022

(30) Foreign Application Priority Data
Apr. 18, 2022 (CN) 202210404070.8

(51) Int. Cl. G21C 3/18; G21C 1/02; G21C 21/02

(52) U.S. Cl. CPC G21C 3/18; G21C 1/02; G21C 21/02

(57) ABSTRACT

The invention belongs to the technical field of nuclear reactor materials design, and discloses a method for improving the withstanding capability of the cladding material in the fast neutron irradiation environment, comprising the following steps: selecting the cladding material with the annular structure and placing it on the outer side of the metallic fuel slug, with leaving a 0.2-0.8 mm gap between the metallic fuel slug and the cladding material; processing the operation in a reactor subsequently, with an annealing process of the fast neutron reactor fuel during the operation of the reactor; improves the withstanding capability of the cladding material in the fast neutron irradiation environment. The invention processes annealing treatment of the cladding material by balancing the internal and external stresses, multiple cycles of steady-state and transient operations, enhancing the withstanding capability of the steel in the high neutron irradiation environment, improving the lifetime of the cladding material.

### 1. TECHNICAL FIELD

The invention relates to the technical field of nuclear reactor materials design, in particular to a method for improving the withstanding capability of the cladding material in the fast neutron irradiation environment.

### 2. BACKGROUND ART

Fast neutron reactors (short for fast reactors) can greatly improve the utilization of uranium resources and achieve a closed fuel cycle. Especially the reactor design of the traveling wave reactors can not only improve the utilization of uranium resources of existing pressurized water reactors by tens of times, but also significantly reduce the yield of nuclear waste and the toxicity of nuclear waste per unit volume. At the same time, the extremely long lifetime design realizes a significant improvement of the reactor economics. Overall, the design concept of the traveling wave reactor forms a strong support for China to achieve the carbon peaking and carbon neutrality goals.

However, since the fuel design of the traveling wave reactor causes extremely high fuel consumption, the cladding material is subjected to an unprecedented irradiation dose of beyond 600 dpa (dpa refers to displacement per atom, which is the most common unit of measurement for irradiation dose). The highest irradiation dose withstood of the currently available international cladding materials is about 200 dpa, which means that the fuel design of the traveling wave reactor requires a significant increase in the irradiation dose withstanding capability of the cladding material.

The traditional materials improvement approach relies on the addition of trace elements and improvement of processing the heat treatment to enhance defect recovery in the reactor irradiation environment, thereby to improve the material's withstanding capability to fast neutron irradiation. The material technology of the ODS steel modulates the behavior of defects by introducing the nano-oxide dispersion particles to increase the pinning of dislocations and thus improve the material's withstanding capability of neutron irradiation, but no high-dose irradiation experiments have confirmed the extent of improvement in neutron irradiation withstanding capability brought by such changes in the microstructure of the material. The failure behavior of the cladding material is reflected in the two main aspects of irradiation embrittlement and irradiation swelling. In general, stainless steel metallic materials have a period of irradiation swelling incubation under the conditions of fast neutron irradiation, where the irradiation-generated vacancy defects do not reach supersaturation and produce significant void growth conditions. However, with increasing irradiation dose, the voids enter into a rapid growth mode resulting in significant irradiation swelling. At the same time, irradiation embrittlement is caused by the segregation of specific elements at the grain boundaries, and such segregation behavior becomes more and more significant with increasing irradiation dose.

In order to improve the withstanding capability of steel materials in neutron irradiation of fast reactors and extend the service life of the materials, the invention provide a method for improving the withstanding capability of the cladding material in the fast neutron irradiation environment.

### 3. SUMMARY OF THE INVENTION

To solve the above problems in the background of the prior art, the invention intended to provide a method for improving the withstanding capability of the cladding material in the fast neutron irradiation environment. The invention processes an annealing treatment of the cladding material by balancing the internal and external stresses, by pressure-bearing on both sides and multiple cycles of steady-state and transient operation, enhancing the withstanding capability of the steel in the high neutron irradiation environment, and improving the lifetime of the cladding material.

To achieve the above aims, the invention provides a technical solution: a method for improving the withstanding capability of the cladding material in the fast neutron irradiation environment:

The invention provides a method for improving the withstanding capability of the cladding material in the fast neutron irradiation environment, comprising the following steps:
selecting the cladding material with the annular structure and placing it on the outer side of the metallic fuel slug, with leaving a 0.2-0.8 mm gap between the metallic fuel slug and the cladding material;
processing the operation in a reactor subsequently, with an annealing process of the fast neutron reactor fuel during the operation of the reactor; and during the annealing process, the gas pressure of both inner surface and the outer surface of the cladding material are adjusted separately to obtain the balance, which improves the withstanding capability of the cladding material in the fast neutron irradiation environment;
the cladding material is steel material.

Further, the regulation of the inner surface gas pressure, and the outer surface gas pressure as well, of the cladding material is achieved by the following steps:
applying an external pressure to the cladding material by means of the primary circuit in the reactor core;
providing a gas channel at the top of the gas plenum of the clad material connected to the gas plenum of the clad material, and providing a pressure plug in the gas plenum; the pressure plug is provided in the shape of an umbrella cover and the inner wall of the pressure plug is in contact with the liquid metal coolant of the primary circuit;
the gas pressure discharges the liquid metal from the pressure plug thereby released to the primary circuit, when the pressure in the gas plenum of the cladding material is 4.3 to 10.3 MPa; and the pressure becomes less once the gas is released, therefore the liquid metal of the primary circuit re-enters the inner wall side of the pressure plug lid to seal the remaining gas, to guarantee the precise control of the gas pressure in the gas plenum by setting the mass of the pressure plug.

Further, the pressure in primary circuit is 3 to 8 MPa.

Further, the fuel slug adopts the high burnup U-50Zr metal fuel with periodic fission gas release.

Further, an annealing process is carried out by a plurality of cycles, and one cycle is a steady-state operation followed by a transient operation.

Further, the steady-state operation is converted to a transient operation when the irradiation damage to the cladding material is in the swelling incubation period and before significant embrittlement occurs.

Further, the temperature of the steady-state operation is at 400 to 600° C.

Further, the temperature of the transient operation is at 700 to 850° C.

Further, the period of the transient operation is 6 to 8 hours.

Further, before performing the first low temperature steady-state operation, prefilling the gas plenum of the cladding material until the internal pressure of the gas plenum is 1 MPa.

Compared with the prior art, the invention has the following advantages:

Compressive stress can directly reduce the diffusion coefficient of defects in the material system and thus reduce defect migration. By introducing compressive stress on both the inner and outer surfaces of the cladding material, the invention can alleviate the voids growth and irradiation segregation behaviors of the cladding material, to achieve a longer irradiation incubation period, and postpone the material failure. High temperature is another factor that can contribute to the postpone of material failure. Irradiated defects in materials exist a recovery behavior with increasing temperature, which is due to the fact that temperature activates a new defect diffusion mechanism that allows for the recombination of irradiation-introduced interstitial and vacancy-type defects. Thus the annealing treatment at a sufficiently high temperature can return the material to be near its unirradiated initial state. Therefore, the invention aims to mitigate irradiation damage by annealing the material at high temperatures.

In order to improve the withstanding capability of steel materials in neutron irradiation of fast reactors and extend the service life of the materials, the invention provide a method for improving the withstanding capability of the cladding material in the fast neutron irradiation environment.

When the fission gas accumulates in the gas plenum, the pressure of the gas plenum of the cladding will rise accordingly, and when the pressure of the gas plenum exceeds the weight of the pressure plug at the top, it will push the pressure plug to open. The pressure plug is provided in the shape of a lid that extends downward, so that the gas is discharged along the inner wall side of the lid of the pressure plug. When the pressure is high enough, the liquid metal is discharged from the pressure plug and released to the primary circuit, and once the gas is released and the pressure becomes low, the liquid metal of the primary circuit re-enters the inner side of the pressure plug and seals the remaining gas, thus achieving precise control of the gas pressure in the gas plenum by setting the mass of the pressure plug. The relationship between the mass of the pressure plug and the pressure in the primary circuit is determined by the fuel dimensions and the operating parameters according to the actual requirements, and there is no need to replace the pressure plug in the course of use.

The invention processes an annealing treatment of the cladding material by balancing the internal and external stresses, by pressure-bearing on both sides and the multiple cycles of steady-state and transient operations, enhancing the withstanding capability of the steel in the high neutron irradiation environment, and improving the lifetime of the cladding material.

### 4. BRIEF DESCRIPTION OF ACCOMPANY DRAWINGS

FIG. 1 is the first steady-state operation: low temperature, pre-gap between fuel and cladding, no obvious inward creep of the cladding (low temperature), reduction of the fuel-cladding gap.

FIG. 2 is the first transient operation: temperature rising, increase in gas pressure of the cladding outer surface, releasing fission gas, rising internal pressure, larger gap and higher fuel, temperature due to different thermal expansion coefficients, fast stabilization of gas internal pressure.

FIG. 3 is the first transient operation: constant temperature, fuel-cladding, gap remaining, internal and external pressure of fission gas in equilibrium, high temperature annealing of the cladding.

FIG. 4 is the first transient operation: temperature reduction, reduction of the fuel-cladding gap, lowering of fuel temperature, higher internal pressure of fission gas than external pressure, outward creep of the cladding, not significant.

FIG. 5 is the second steady-state operation: low temperature, maintenance of internal pressure of fission gas, higher internal pressure than external pressure, outward creep of the cladding, not significant, widening of fuel-cladding gap.

FIG. 6 is the second transient operation: temperature rising, larger gap, rising fuel temperature, up to the constant temperature pressure equilibrium.

FIG. 7 is the second transient operation: constant temperature, fuel-cladding gap remaining, internal and external pressure of fission gas in equilibrium, high temperature annealing of the cladding.

FIG. 8 is the second transient operation: temperature reduction, reduction of the fuel-cladding gap, lowering of fuel temperature, higher internal pressure of fission gas than external pressure, outward creep of the cladding, not significant.

FIG. 9 is the n steady-state operation: low temperature, higher internal pressure than external pressure, outward creep of the cladding, not significant, widening of fuel-cladding gap, greater fuel swelling than cladding creep, gradual reduction of fuel-cladding gap until contact.

FIG. 10 is the n steady-state operation: low temperature, contacted, contact of fuel and cladding, outward creep of the cladding, not significant.

FIG. 11 is the n transient operation: temperature rising, opening of fuel-cladding gap, rising of fuel temperature, higher internal pressure of fission gas than external pressure, outward creep of the cladding until pressure equilibrium.

FIG. 12 is the n transient operation: constant temperature, opening of fuel-cladding gap, high temperature annealing of the cladding.

FIG. 13 is the n transient operation: temperature reduction, contact of fuel and cladding, outward creep of the cladding.

FIG. 14 is the n+1 steady-state operation: low temperature, contact of fuel and cladding, outward creep of the cladding, possible breakage of the cladding.

### 5. SPECIFIC EMBODIMENT OF THE INVENTION

To make the technical solutions provided by the invention more comprehensible, a further description of the invention is given below in combination with the attached drawings and embodiments, and the embodiments are exemplary and not the limitations of the scope of the disclosure.

### Embodiment 1

The embodiment provides a method for improving the withstanding capability of the cladding material in the fast neutron irradiation environment, comprising the following steps:
selecting the metallic fuel slug with an annular geometry, an inner central hole diameter of 1 mm, and a fuel slug outer diameter of 9 mm as the fuel of the embodiment.
selecting the cladding material with an annular geometry, an inner diameter of 8 mm and an outer diameter of 11 mm; providing a gas channel at the top of the gas chamber of the clad material connected to the gas plenum of the clad material, and providing a pressure plug in the gas channel, to obtain the cladding material of the embodiment.

The embodiment comprises the following steps: applying the external pressure to the cladding material by means of the primary circuit in the reactor core; the pressure plug is provided in the shape of an umbrella cover and the inner wall of the pressure plug is in contact with the liquid metal coolant of the primary circuit; directly calculating the upper pressure limit according to the gas pressure, steady-state operation and annealing temperature of primary circuit after using the relationship PV=nRT; when the pressure in the gas chamber reaches this pressure limit, such as 7.3 MPa, the gas pressure discharges the liquid metal from the pressure plug thereby released to the primary circuit; and the pressure becomes less until the gas plenum pressure returns to the set upper limit once the gas is released, therefore the liquid metal of the primary circuit re-enters the inner wall side of the pressure plug lid to seal the remaining gas, to guarantee the precise control of the gas pressure in the gas plenum by setting the mass of the pressure plug; the pressure plug mass m is determined by the pressure value of the pressure set in primary circuit and the high temperature pressure balance, that is m×g/S=Pᵢₙ.

Wherein S is the surface stressed area under the pressure plug, and
the Pᵢₙ is the set internal pressure of fuel rod, determined by the primary circuit pressure: Pᵢₙ=Pₒᵤₜ, and
the Pₒᵤₜ is the temperature in the annealed condition of the primary circuit, determined by the steady-state operating pressure of the primary circuit P₁: Pₒᵤₜ/Tₜ=P₁/Tₛ, and
Tₛ is the outlet temperature for the steady-state operation of the primary circuit, and
Tₜ is the temperature of the primary circuit annealing operation, and
P₁ is the pressure of the primary circuit steady-state operation.

Providing the cladding material on the outer side of the fuel slug, with leaving a 0.5 mm gap between the fuel and the cladding material and to obtain the fast neutron reactor fuel material of the embodiment.

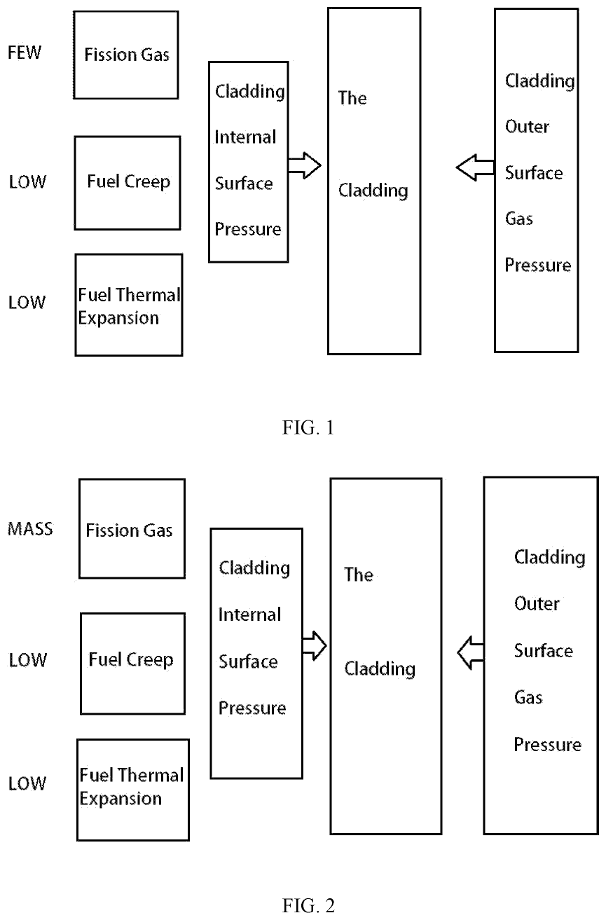

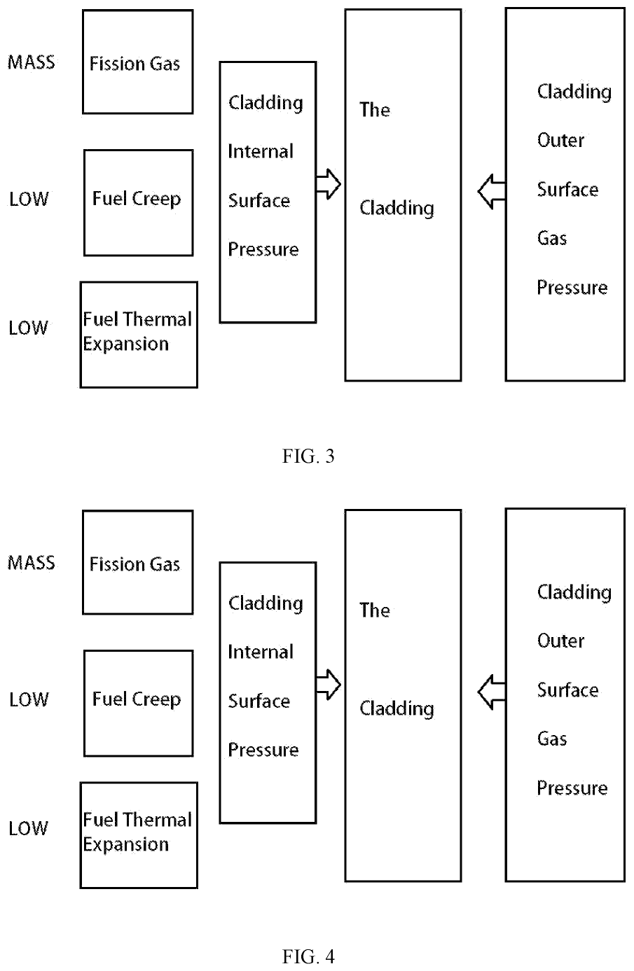

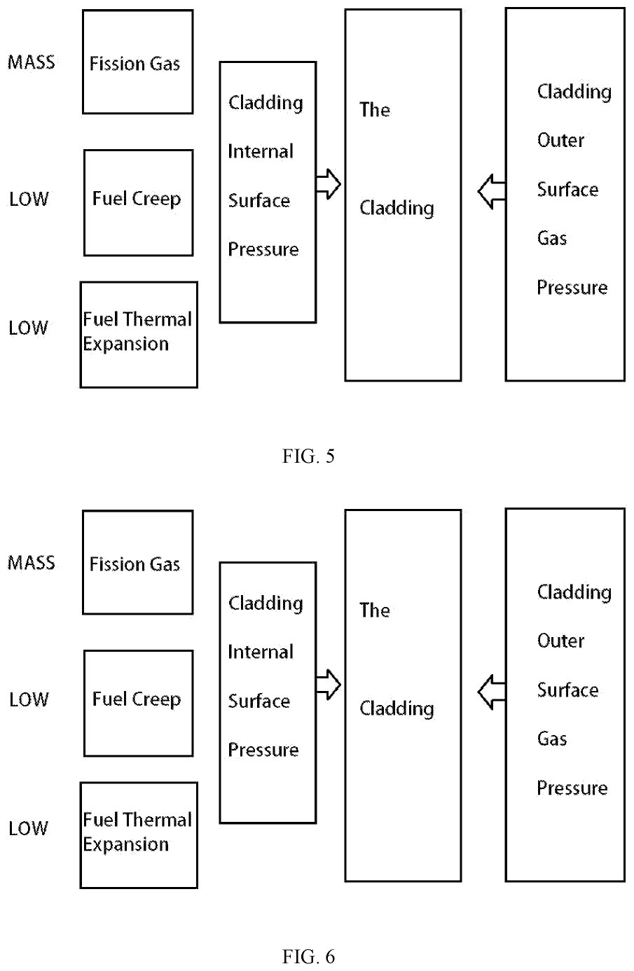

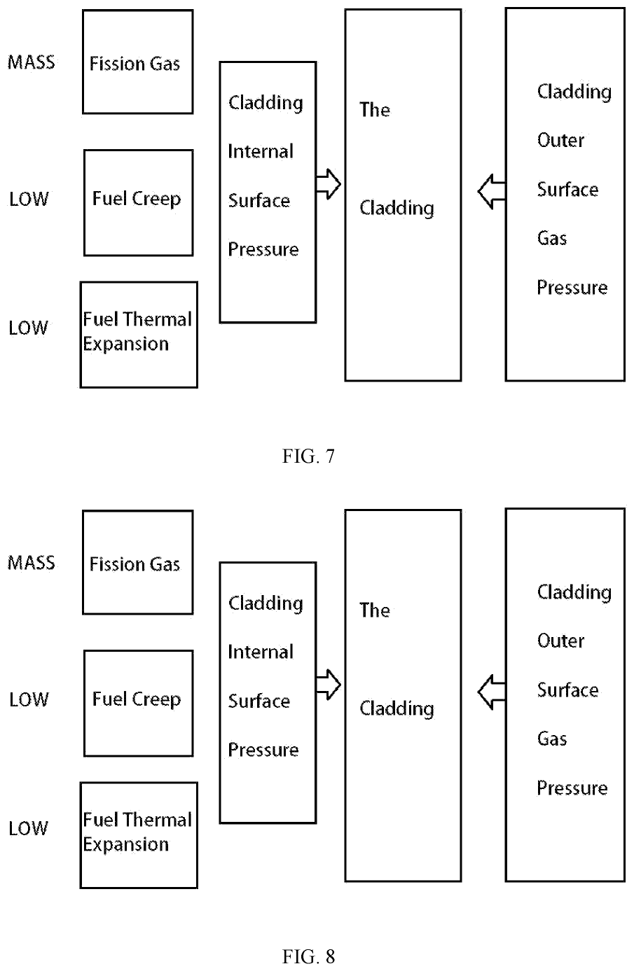

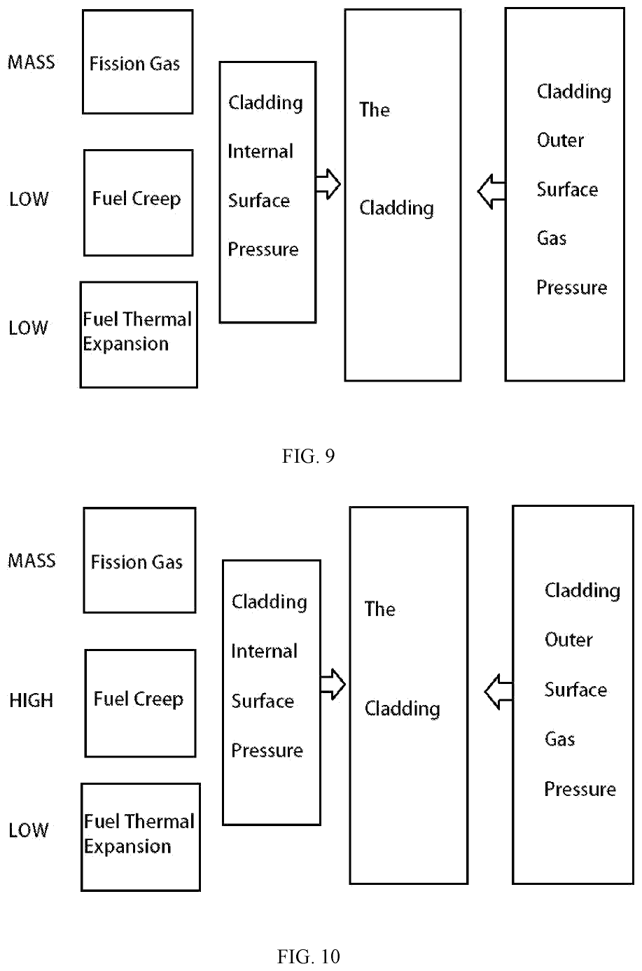

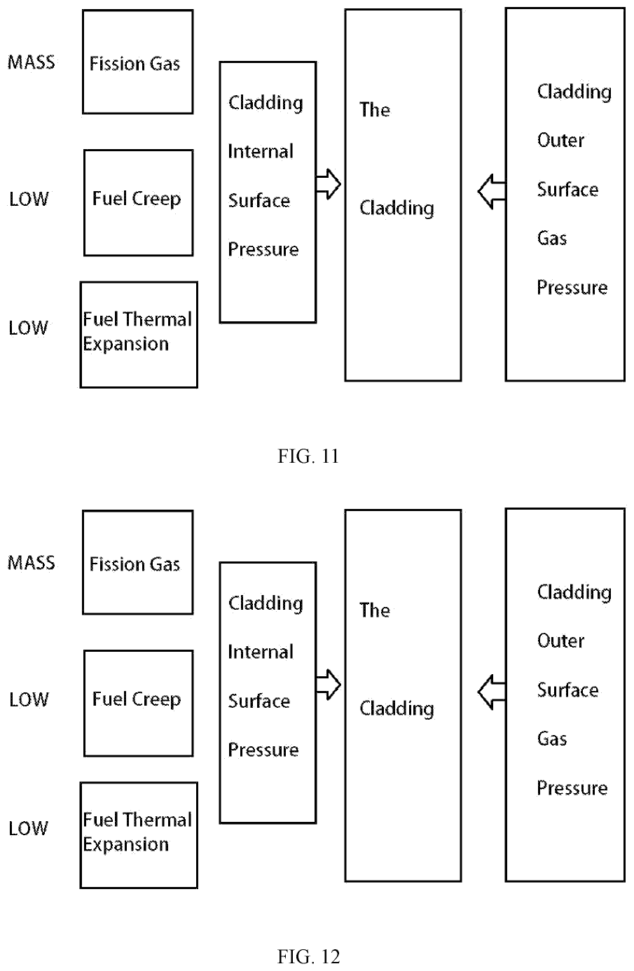

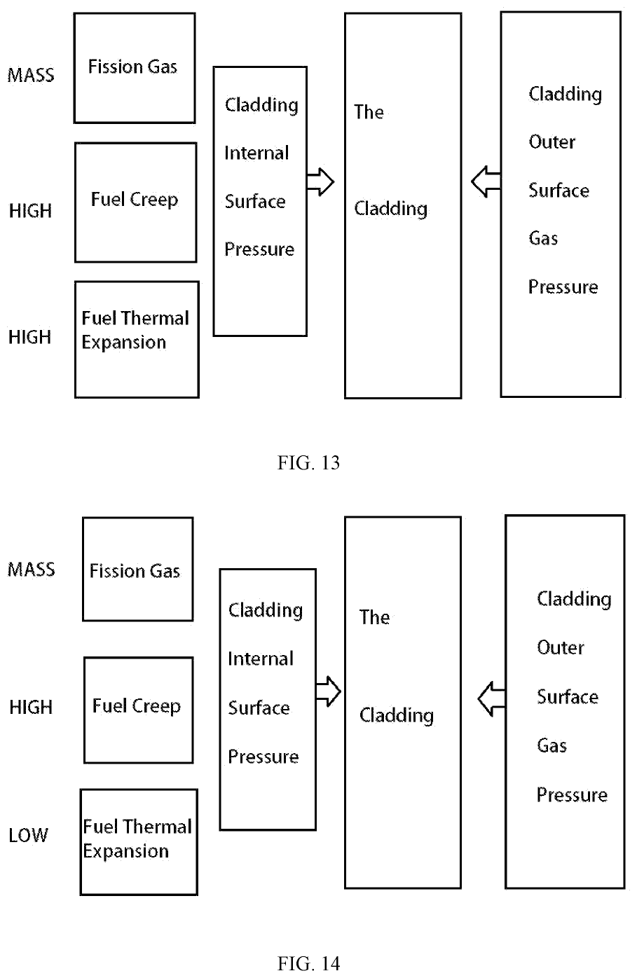

When the first steady-state operation of the fast neutron reactor fuel material of the embodiment in the reactor, the fuel slug and the cladding will not come into contact and the fission gas has not been released because the fuel slug is in a low-temperature low swelling state; therefore, there is no fission gas pressure in the cladding, and the fuel is prefilled with 1 MPa of gas to keep it in basic balance with the external pressure; a slightly higher external pressure slowly creep the cladding inward. The reactor core operation state of the steady-state operation is artificially adjusted when the irradiation damage to the cladding material is in the swelling incubation period and before occurring the significant embrittlement, to achieve the primary circuit coolant temperature rise from 500° C. in steady-state operation to 880° C. in transient operation (reactor 0 power operation). The warming process is accompanied by a greater thermal expansion of the cladding than the fuel expansion, widening the fuel-cladding gap and rising the fuel temperature to 900° C. At the same time, the increase in coolant temperature increases the fuel temperature to drive a large fractional release of fission gas, causing the pressure inside the cladding to increase to the maximum internal pressure controlled by the pressure plug. The maximum pressure set by the pressure plug at the top of the cladding is equal to the pressure in the primary circuit at the maximum planned operating temperature of the cladding at transient operation. In this way, the internal and external pressures achieve complete equilibrium when the cladding temperature rises to the specified annealing temperature (at this time the reactor is in 0 power operation and the only heat generated inside the fuel is the residual decay heat, thus, the coolant axial temperature difference is only 10-20° C.). Due to the massive release of fission gas, the fuel swelling is not obvious, and the fuel-cladding gap is still open. The cladding is annealed for 7 hours in this high-temperature transient operating condition to restore plasticity and recover the irradiation defects. At the end of the high temperature transient operation, the thermodynamic hydraulic operation state is artificially adjusted to cool down the coolant and the reactor is restarted and reaches its rated power. During the cooling process, the fuel shrinkage is smaller than cladding shrinkage, but the fuel and cladding are still not in contact due to the initially set fuel-cladding gap. As the coolant temperature decreases causing the external pressure to drop, and thus the internal gas pressure is slightly greater than the external gas pressure, the cladding creeps outward in small increments until the temperature returns to steady-state operation. The fuel returns to a low swelling spinodal decomposition two-phase state for the second steady-state operation. As shown in FIG. 1, the 10th low-temperature operation after several cycles of operation results in contact between the fuel and the cladding due to the continuous swelling of the fuel, which causes the cladding to start creeping outward slowly (low temperature and low creep). The fuel-cladding gap opens again during the 10th transient operation ramp-up and high-temperature constant temperature operation, therefore the cladding is still relatively safe for the transient operation. However, when entering the steady-state operation phase in the 11th operating cycle, there may be a risk of cladding failure and reactor shutdown due to continuous creep of the fuel-cladding contact outward.

### Embodiment 2

The embodiment provides method for improving the withstanding capability of the cladding material in the fast neutron irradiation environment and the differences between the embodiment and Embodiment 1 are as follows:

In the embodiment, selecting the fuel slug with an annular geometry, an inner central hole diameter of 0.2 mm, and a fuel slug outer diameter of 5 mm.

In the embodiment, selecting the cladding material with an annular geometry, an inner central hole diameter of 5.2 mm, and a fuel slug outer diameter of 6.2 mm.

In the embodiment, leaving 0.2 mm between the fuel and the cladding material.

In the embodiment, the steady-state operation temperature for each per cycle is 400° C.

In the embodiment, the transient operation temperature for each cycle is 700° C. and the transient operation period is 6 hours.

In the embodiment, the fuel-cladding gap opens again during the 7th transient operation ramp-up and high-temperature constant temperature operation, therefore the cladding is still relatively safe for the transient operation. However, when entering the steady-state operation phase in the 8th operating cycle, there may be a risk of cladding failure and reactor shutdown due to continuous creep of the fuel-cladding contact outward.

### Embodiment 3

The embodiment provides method for improving the withstanding capability of the cladding material in the fast neutron irradiation environment and the differences between the embodiment and Embodiment 1 are as follows:

In the embodiment, selecting the fuel slug with an annular geometry, an inner central hole diameter of 2 mm, and a fuel slug outer diameter of 13 mm.

In the embodiment, selecting the cladding material with an annular geometry, an inner central hole diameter of 13.8 mm, and a fuel slug outer diameter of 15.8 mm.

In the embodiment, leaving 0.8 mm between the fuel and the cladding material.

In the embodiment, the steady-state operation temperature for each per cycle is 600° C.

In the embodiment, the transient operation temperature for each cycle is 850° C. and the transient operation period is 8 hours.

In the embodiment, the 10th low-temperature operation after 9 cycles of operation results in contact between the fuel and the cladding due to the continuous swelling of the fuel slug, which causes the cladding to start creeping outward slowly (low temperature and low creep). the fuel-cladding gap opens again during the 9th transient operation ramp-up and high-temperature constant temperature operation, therefore the cladding is still relatively safe for the transient operation. However, when entering the steady-state operation phase in the 10th operating cycle, there may be a risk of cladding failure and reactor shutdown due to continuous creep of the fuel-cladding contact outward.

The above embodiments are only to illustrate the technical idea of the invention and not intended to limit the scope of protection of the invention. Any transformations made on the basis of technical solutions with the technical ideas of the invention will fall within the scope of protection of the invention; the technology not covered by the invention can be realized by the prior art.

The above description of the invention and the embodiments thereof is not restricted, and the accompanying drawings are only one of the embodiments of the invention, and the actual structure is not limited thereto. In conclusion, the similar structures and embodiments with the technical scheme of the invention, which are designed by the general skilled person in the art inspired by the invention, without creativity and without departing from the spirit of the invention, should be included in the protection scope of the invention.

1. A method for improving the withstanding capability of the cladding material in the fast neutron irradiation environment, wherein comprises the following steps:
selecting the cladding material with the annular structure and placing it on the outer side of the metallic fuel slug, with leaving a 0.2-0.8 mm gap between the metallic fuel slug and the cladding material;
processing the operation of fast neutron reactor fuel material in a reactor subsequently, with an annealing process of the fast neutron reactor fuel during the operation of the reactor; and during the annealing process, the gas pressure of both inner surface and the outer surface of the cladding material are adjusted separately to obtain the force equilibrium, which improves the withstanding capability of the cladding material in the fast neutron irradiation environment;
the cladding material is steel material.

2. The method of claim 1, wherein the regulation of the inner surface gas pressure, and the outer surface gas pressure as well, of the cladding material is achieved by the following steps:
applying the external pressure to the cladding material by means of the primary circuit in the reactor core;
providing a gas channel at the top of the gas plenum of the clad material connected to the gas plenum of the clad material, and providing a pressure plug in the gas channel; the pressure plug is provided in the shape of an umbrella cover and the inner wall of the pressure plug is in contact with the liquid metal coolant of the primary circuit;
the gas pressure discharging the liquid metal from the pressure plug thereby released to the primary circuit, when the pressure in the gas chamber of the cladding material is 4.3 to 10.3 MPa; and the pressure becomes less once the gas is released, therefore the liquid metal of the primary circuit re-enters the inner wall side of the pressure plug lid to seal the remaining gas, to guarantee the precise control of the gas pressure in the gas plenum by setting the mass of the pressure plug.

3. The method of claim 2, wherein the pressure in the primary circuit is 3 to 8 MPa.

4. The method of claim 1, wherein the metallic fuel slug adopts the high burnup U-50Zr metal fuel with periodic fission gas release.

5. The method of claim 1, wherein the annealing process is carried out by a plurality of cycles, and one cycle is a steady-state operation followed by a transient operation.

6. The method of claim 5, wherein the steady-state operation is converted to a transient operation when the irradiation damage to the cladding material is in the swelling incubation period and before significant embrittlement occurs.

7. The method of claim 5, wherein the temperature of the steady-state operation is at 400 to 600° C.

8. The method of claim 5, wherein the temperature of the transient operation is at 700 to 850° C.

9. The method of claim 5, wherein the period of the transient operation is 6 to 8 hours.

10. The method of claim 5, wherein before performing the first low temperature steady state operation, prefilling the gas plenum of the cladding material until the internal pressure of the gas plenum is 1 MPa.
